(19) United States
(12) Patent Application Publication
(10) Pub. No.: US 2020/0290541 A1
(43) Pub. Date: Sep. 17, 2020

(54) BIOLOGICAL INFORMATION OUTPUT DEVICE, BIOLOGICAL INFORMATION OUTPUT METHOD, AND NON-TRANSITORY COMPUTER-READABLE MEDIUM

(71) Applicant: Shigetomo Mitani, Aichi (JP)

(72) Inventor: Shigetomo Mitani, Aichi (JP)

(73) Assignee: NIDEC MOBILITY CORPORATION, Aichi (JP)

(21) Appl. No.: 16/816,375

(22) Filed: Mar. 12, 2020

(30) Foreign Application Priority Data
Mar. 13, 2019 (JP) 2019-046339

(51) Int. Cl. B60R 21/015; G06K 9/00; G06N 20/00

(52) U.S. Cl. CPC B60R 21/01534; G06N 20/00; G06K 9/00362; B60R 21/01542

(57) ABSTRACT

A biological information output device outputs: information about a distance to a living body obtained by processing an I signal obtained by multiplying a signal of an electromagnetic wave and a signal of a reflected wave of the electromagnetic wave reflected on the living body and a Q signal obtained by delaying the I signal by a predetermined phase; a reception intensity of the reflected wave using a diameter of a circle drawn by a signal point obtained by developing the I signal and the Q signal on a complex plane; and a phase change amount of the reflected wave using a displacement angle of a range where the signal point is displaced on the circle with respect to a center of the circle. The device determines a type of the living body based on the distance, the reception intensity, and the phase change amount.

### CROSS-REFERENCES TO RELATED APPLICATIONS

This application is based upon and claims the benefit of priority from Japanese Patent Application No. 2019-046339, filed on Mar. 13, 2019; the entire contents of which are incorporated herein by reference.

### FIELD

One or more embodiments of the present invention relate to a biological information output device for determining a type of a living body.

### BACKGROUND

In the related art, a technique has been developed for detecting the presence or absence of an occupant in a vehicle and for determining whether the detected occupant is an adult or a child, for the purpose of defining conditions for operation of an airbag of the vehicle, or the like.

For example, JP-A-2003-315141 describes determining whether an occupant is an adult or a child based on a result of detecting the weight of the occupant by a load sensor provided under a seat of a vehicle.

Further, JP-A-2006-208241 describes taking out a differential signal of output between a pair of thermopile sensors, detecting whether or not an occupant is seated by using the signal, and distinguishing between an adult and a child of the occupant by using an output difference between respective stages in an array of thermopile elements.

### SUMMARY

However, in the techniques described in JP-A-2003-315141 and JP-A-2006-208241, it is difficult to determine the correct weight and body size depending on the seating position, and it is often erroneously determined whether an occupant is an adult or a child.

An object of one or more embodiments of the present invention is to accurately distinguish a type of a living body.

In order to solve the above problems, a biological information output device according to an aspect of the present invention includes: an irradiation unit that irradiates a body surface of a living body with an electromagnetic wave; a reception unit that receives a reflected wave of the electromagnetic wave reflected on the body surface; a reception information processing unit that outputs information about a distance to the body surface of the living body obtained by processing an I signal and a Q signal, the I signal being obtained by multiplying a signal of the electromagnetic wave and a signal of the reflected wave, and the Q signal being obtained by delaying the I signal by a predetermined phase, outputs a reception intensity of the reflected wave using a diameter of a circle drawn by a signal point obtained by developing the I signal and the Q signal on a complex plane, and outputs a phase change amount of the reflected wave using a displacement angle of a range where the signal point is displaced on the circle with respect to a center of the circle; and a living body determination unit that determines a type of the living body based on the distance, the reception intensity, and the phase change amount.

In order to solve the above problems, a biological information output method according to another aspect of the present invention includes: outputting information about a distance to a body surface of a living body obtained by processing an I signal and a Q signal, the I signal being obtained by multiplying a signal of an electromagnetic wave with which the body surface of the living body is irradiated and a signal of a reflected wave of the electromagnetic wave reflected on the body surface, and the Q signal being obtained by delaying the I signal by a predetermined phase; outputting a reception intensity of the reflected wave using a diameter of a circle drawn by a signal point obtained by developing the I signal and the Q signal on a complex plane; outputting a phase change amount of the reflected wave using a displacement angle of a range where the signal point is displaced on the circle with respect to a center of the circle; and determining a type of the living body based on the distance, the reception intensity, and the phase change amount.

According to the above configuration, a reception signal mainly includes information about a distance between a living body and the reception unit, and the reception intensity becomes stronger as the distance between the living body and the reception unit is shorter and the body size of the living body is larger. Further, when a living body is positioned at the same position, the distance between the living body and the reception unit is closer as the body size of the living body is larger. In addition, the phase change mainly includes information about a respiration cycle and the size of the respiration. The respiration cycle and the phase change amount due to respiration are greatly related to the body size of the living body. Therefore, based on the reception intensity and the phase change amount, it is possible to more accurately determine the type of the living body regardless of the seating position of the living body.

The biological information output device may further include an angular velocity calculation unit that calculates an angular velocity using the displacement angle; and a biological information processing unit that outputs biological information unique to the living body using the angular velocity, in which the living body determination unit may determine the type of the living body based on the biological information.

According to the above configuration, it is possible to more accurately determine the type of the living body based on the biological information such as a respiration rate or a pulse rate.

The living body determination unit may create a learning model by performing machine learning based on teacher data, which uses the distance, the reception intensity, and the phase change amount as input data and uses a type of the living body that can be actually determined as output data, and determine a type of the living body according to the learning model.

According to the above configuration, the living body determination unit creates a learning model capable of realizing a more diverse determination algorithm by repeating learning, and determines a type of a living body using the learning model. Thereby, the number of cases that cannot be determined can be reduced.

The biological information output device may further include an angular velocity calculation unit that calculates an angular velocity using the displacement angle, in which the living body determination unit may determine that the living body is a child when a magnitude of the angular velocity calculated by the angular velocity calculation unit is maintained to be equal to or greater than a predetermined value for a certain number of times or more within a predetermined time.

According to the above configuration, it is determined that the occupant made a large movement for a predetermined period of time or longer is a child. Thereby, it is possible to determine even an occupant who is not in a resting state.

The biological information output device according to yet another aspect of the present invention may be implemented by a computer, and in this case, a biological information output program that causes the computer to implement the biological information output device by causing the computer to operate as each unit (software element) included in the biological information output device, and a recording medium readable by a computer and storing the program are also included in the scope of one or more embodiments of the present invention.

According to one or more embodiments of the present invention, it is possible to accurately distinguish a type of a living body.

### BRIEF DESCRIPTION OF DRAWINGS

FIG. 1 is a diagram showing a disposition of a biological information output device according to an embodiment of the present invention in a vehicle interior.

FIG. 2 is a block diagram showing a configuration of the biological information output device.

FIG. 3 is a flowchart showing a procedure of occupant determination processing by the biological information output device.

FIG. 4A is a diagram showing an IQ plane obtained by a biological information extraction unit in the biological information output device based on a reception signal of a reflected wave from an adult occupant, and FIG. 4B is a diagram showing an IQ plane obtained by the biological information extraction unit based on a reception signal of a reflected wave from a child occupant.

FIG. 5A is a waveform diagram showing measurement data from which biological information is to be extracted by the information extracting unit of the biological information output device, and FIG. 5B is a waveform diagram showing bandpass filter processing by the information extraction unit.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

### Embodiment 1

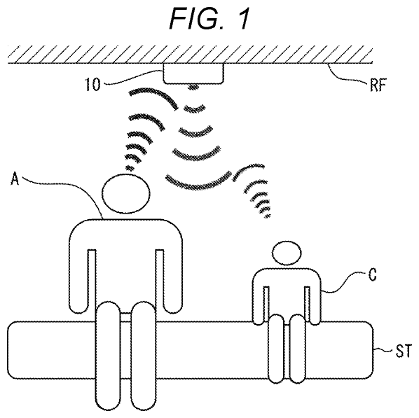

One embodiment of the present invention is described below with reference to FIGS. 1 to 5B.

FIG. 1 is a diagram showing a disposition of a biological information output device 10 according to the embodiment in a vehicle interior.

As shown in FIG. 1, the biological information output device 10 is disposed in a roof RF of the vehicle interior. The biological information output device 10 irradiates an occupant sitting on a seat ST in the vehicle interior with an electromagnetic wave, and outputs occupant determination information for determining whether the occupant is an adult A or a child C based on a signal of a reflected wave reflected from the occupant.

Next, the biological information output device 10 will be described in detail.

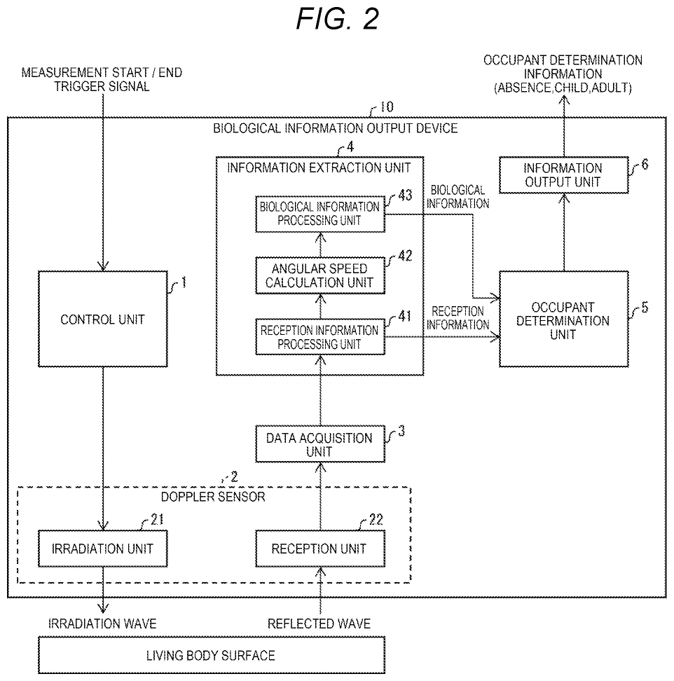

FIG. 2 is a block diagram showing a configuration of the biological information output device 10.

As shown in FIG. 2, the biological information output device 10 includes a control unit 1, a Doppler sensor 2, a data acquisition unit 3, an information extraction unit 4, an occupant determination unit 5 (living body determination unit), and an information output unit 6.

The control unit 1 controls the Doppler sensor 2. When a measurement start trigger signal is input, the control unit 1 instructs an irradiation unit 21 of the Doppler sensor 2 to perform irradiation of electromagnetic waves, and when a measurement end trigger signal is input, the control unit 1 instructs the irradiation unit 21 of the Doppler sensor 2 to stop the irradiation of the electromagnetic wave.

The measurement start trigger signal is a signal serving as a trigger for starting occupant determination processing. As the measurement start trigger signal, an ON signal of a seat belt switch, which can assume a timing almost close to the start of driving, is used. The measurement end trigger signal is a signal serving as a trigger for ending the occupant determination processing. As the measurement end trigger signal, an OFF signal of the seatbelt switch, which can assume a timing almost close to the end of driving, is used. By using such a measurement start trigger signal and a measurement end trigger signal, determination processing of an occupant is performed while a vehicle is traveling.

The Doppler sensor 2 includes an irradiation unit 21, and a reception unit 22. The irradiation unit 21 emits an electromagnetic wave and irradiates a body surface (living body surface) of an occupant (adult A and child C in FIG. 1) with the electromagnetic wave as an irradiation wave. The reception unit 22 receives a reflected wave of the electromagnetic wave reflected on a living body surface, the living body surface being irradiated with the electromagnetic wave by the irradiation unit 21, performs wave detection, amplification, and the like, and outputs an I signal obtained by multiplying the signal of emitted electromagnetic wave by the signal of received reflected wave, and a Q signal obtained by delaying the I signal by a predetermined phase.

The data acquisition unit 3 acquires measurement data by performing predetermined processing on the I signal and the Q signal from the reception unit 22. The data acquisition unit 3 outputs the acquired measurement data to the information extraction unit 4. Specifically, the data acquisition unit 3 converts analog I and Q signals into digital signals, and outputs the digital I and Q signals as measurement data. Note that the data acquisition unit 3 is provided outside the Doppler sensor 2, but may be included in the Doppler sensor 2.

The information extraction unit 4 extracts the reception information and the biological information based on the measurement data output from the data acquisition unit 3. The reception information is information obtained from the reception signal output by the reception unit 22 receiving the reflected wave, and includes a distance between the Doppler sensor 2 and the occupant, a reception intensity, and a phase in an IQ plane formed by the I signal and the Q signal. The biological information is information about a respiration rate and a heartbeat rate of an occupant.

The information extraction unit 4 includes a reception information processing unit 41, an angular velocity calculation unit 42, and a biological information processing unit 43 in order to extract the reception information and the biological information.

The reception information processing unit 41 develops the I signal and the Q signal of the measurement data output from the data acquisition unit 3 on the IQ plane (complex plane), and outputs a diameter of a circle represented by the I signal and the Q signal on the IQ plane and a range (displacement angle) of a reception signal point (signal point) displaced on the circle.

The size of the circle is proportional to the intensity of the reception signal (hereinafter referred to as “reception intensity”). The closer the position of the occupant to the Doppler sensor 2, that is, the shorter the distance between the reception unit 22 of the Doppler sensor 2 and the occupant, the larger the circle. Further, the larger the reflection area in which the reflected wave is reflected from the occupant, the larger the circle. Therefore, the type of the occupant (mainly adult or child) can be determined by the size of the circle, and the accuracy is high in determining the body size difference of the occupant.

Further, the change on the circle of the reception signal point represented by the I signal and the Q signal on the IQ plane represents the phase change amount of the reception signal, and is displaced according to respiration and pulse. Because an adult has a large lung, respiration is large, and the number of respiration is small, so that the reception signal point due to the reflected wave from an adult is displaced slowly and largely on a circle (a cycle is long and a phase change amount is large). Because a child has a small lung, respiration is small, and the number of respiration is large, so that the reception signal point due to the reflected wave from a child is displaced quickly and small on a circle (a cycle is short and a phase change amount is small). The pulse is slow in adults and fast in children, so there is a difference between adults and children as well as respiration. Therefore, it is possible to determine the body size difference of the occupant by the phase change amount and the cycle (respiration rate and pulse rate) relating to the respiration and pulse of the reception signal point.

The angular velocity calculation unit 42 calculates the angular velocity of the reception signal point in the IQ plane based on the data obtained by the reception information processing unit 41 developing the I signal and the Q signal on the IQ plane, and outputs the angular velocity signal. The angular velocity is largely related to the size of respiration and the number of respiration, as described above. The angular velocity ω is expressed by the following equation (time derivative of displacement angle), where the above displacement angle is θ.

ω=dθ/dt

The angular velocity calculation unit 42 calculates an angular velocity using the above equation, and outputs the angular velocity signal. The angular velocity signal has a waveform in which the respiration and pulse appear as cyclical peaks. However, the peak of respiration is predominantly larger than the peak of pulse.

The biological information processing unit 43 extracts biological information based on the angular velocity signal calculated by the angular velocity calculation unit 42. Specifically, the biological information processing unit 43 converts a value of each amplitude including the peak of the angular velocity signal into a Fourier transform signal representing a frequency spectrum by Fourier transforming the angular velocity signal, and outputs the respiration rate and the heartbeat rate as biological information by performing filter processing on the Fourier transform signal.

The occupant determination unit 5 determines whether the occupant is an adult or a child based on the distance, the reception intensity, and the phase change amount in the reception information which is output from the reception information processing unit 41. Specifically, the occupant determination unit 5 determines whether the occupant is an adult or a child based on whether or not each of the reception intensity and the phase change amount exceeds a prescribed threshold value. Alternatively, in particular, the occupant determination unit 5 uses a map of three axes representing the distance, the reception intensity, and the phase change amount on the respective axes, and performs a determination based on whether the respective values of the distance, the reception intensity, and the phase change amount belong to an area for determining an adult on the map or an area for determining a child.

The occupant determination unit 5 may determine whether or not the occupant is an adult or a child based on whether each of the respiration rate and the heartbeat rate exceeds the prescribed threshold value.

The information output unit 6 outputs the occupant determination information, which is a result inverted by the occupant determination unit 5, to the outside of the biological information output device 10. The occupant determination information includes information about the absence of an occupant, the occupant of an adult, and the occupant of a child.

Next, an operation of the biological information output device 10 configured as described above will be described.

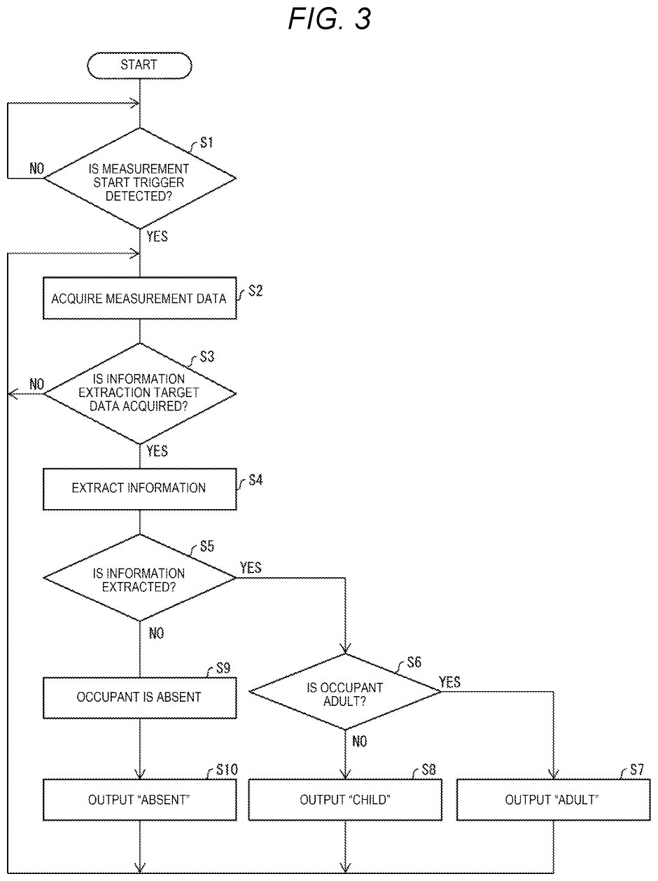

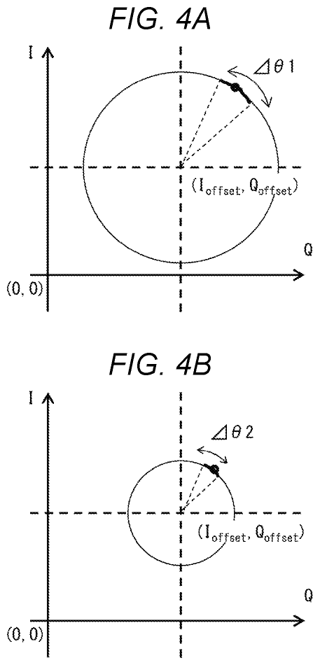

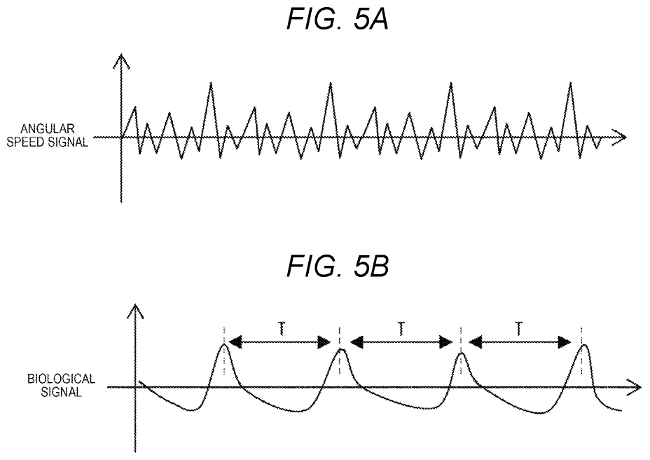

FIG. 3 is a flowchart showing a procedure (biological information output method) of occupant determined processing performed by the biological information output device 10. FIG. 4A is a diagram showing an IQ plane obtained by the information extraction unit 4 based on a reception signal of a reflected wave from an adult occupant. FIG. 4B is a diagram showing an IQ plane obtained by the information extraction unit 4 on based on a reception signal of a reflected wave from a child occupant. FIG. 5A is a waveform diagram showing measurement data from which biological information is to be extracted by the information extracting unit 4 of the biological information output device 10. FIG. 5B is a waveform diagram showing bandpass filter processing by the information extraction unit 4.

First, as shown in FIG. 3, the control unit 1 determines whether or not a measurement start trigger is detected (step S1). The control unit 1 waits until the measurement start trigger is detected (YES in step S1). When the measurement start trigger is detected, the control unit 1 instructs the irradiation unit 21 of the Doppler sensor 2 to perform irradiation of electromagnetic waves. Thereby, when the irradiation unit 21 irradiates an occupant with the electromagnetic wave, the reception unit 22 receives a reflected wave from the occupant and outputs a reception signal in the form of, for example, an I signal and a Q signal.

When the number of occupants is two or more, the Doppler sensor 2 receives reflected waves where the emitted electromagnetic waves are reflected from the two or more occupants. The reflected wave is a synthesized wave in which the reflected waves of all the occupants overlap. The Doppler sensor 2 may obtain a reflected wave for each occupant by separating the synthesized wave by known signal processing.

When the occupants are an adult and a child, the distance difference between the reflected waves from the respective occupants is large, which makes it easy to separate the synthesized wave, but when all the occupants are adults or children, the distance difference between the reflected waves from the respective occupants is small, which may make it difficult to separate the synthesized wave. In such a case, the Doppler sensor 2 may rotate the irradiation unit 21 at a predetermined angle to displace an emission direction of the electromagnetic wave. Thereby, it is possible to obtain reflected waves for each occupant.

Next, the data acquisition unit 3 acquires measurement data from the detection signal from the Doppler sensor 2 (step S2). The data acquisition unit 3 determines whether or not measurement data from which information is to be extracted by the information extracting unit 4, is acquired (step S3). In step S3, the data acquisition unit 3 determines, for example, whether or not the measurement data is abnormal data. The abnormal data includes data obtained when the occupant moves greatly.

In step S3, when the data acquisition unit 3 determines that the measurement data that can be an object of information extraction is not acquired (NO), the data acquisition unit 3 returns the process to step S2 and acquires new measurement data. Further, in step S3, when the data acquisition unit 3 determines that the measurement data that can be an object of information extraction is acquired (YES), the information extraction unit 4 extracts the reception information and biological information based on the measurement data (step S4, reception information processing step).

In the information extraction unit 4, the reception information processing unit 41 develops the I signal and the Q signal of the measurement data on, for example, an IQ plane as shown in FIGS. 4A and 4B. In the IQ plane shown in FIG. 4A, since the diameter of the circle is large and the displacement angle AO 1 is large, it is understood that the I signal and the Q signal are based on the reflected wave from an adult. In the IQ plane shown in FIG. 4B, since the diameter of the circle is small and the displacement angle AO 2 is small, it is understood that the I signal and the Q signal are based on the reflected wave from a child.

The IQ plane indicates the amplitude and phase of the reception signal with the coordinates (Ioffset, Qoffset) as a center. The Ioffset and Qoffset are constants determined by the installation condition of the Doppler sensor 2.

In the information extraction unit 4, the angular velocity calculation unit 42 outputs an angular velocity signal, for example, as shown in FIG. 5A, based on the data output from the reception information processing unit 41.

In the information extraction unit 4, the biological information processing unit 43 performs filter processing on the Fourier transform signal obtained by Fourier transforming the angular velocity signal output from the angular velocity calculation unit 42, and extracts a biological signal of a cycle T shown in FIG. 5B, for example.

When the determination is performed for a plurality of occupants, even when the separation of the synthesized wave is difficult as described above, respiration cycles of the occupants do not completely match with each other. Therefore, the biological information processing unit 43 can output the respiration rate of the respiration cycle different for each occupant as the biological information.

The information extraction unit 4 determines whether or not the reception information and the biological information for each occupant is extracted (step S5). In step S5, when the information extraction unit 4 determines that the reception information and the biological information can be extracted (YES), the occupant determination unit 5 determines whether or not the occupant is an adult (step S6). In step S6, when the occupant determination unit 5 determines that the occupant is an adult (YES), the information output unit 6 outputs the occupant determination information indicating that the occupant is an adult as the determination result acquired from the occupant determination unit 5 (step S7), and returns the process to step S2. In step S6, when the occupant determination unit 5 determines that the occupant is not an adult (child) (NO), the information output unit 6 outputs the occupant determination information indicating that the occupant is a child as a determination result acquired from the occupant determination unit 5 (step S8), and returns the process to step S2.

In step S5, when the information extraction unit 4 determines that the reception information and the biological information cannot be extracted (NO), the occupant determination unit 5 determines that the occupant is absent (step S9). In response to the determination result, the information output unit 6 outputs the occupant determination information indicating that the occupant is absent (step S10), and returns the process to step S2.

The occupant determination unit 5 performs the determination of the occupant by the processing of steps S6 to S10 (living body determination step).

Note that in the present embodiment, the occupant determination unit 5 determines an adult or a child as an occupant, but may be configured to further distinguish and determine small animals such as pets. In such a configuration, the occupant determination unit 5 further provides determination processing of whether or not the occupant is a child when it is determined that the occupant is not an adult in the above-described Step S6, and determines whether or not the occupant is a child in the determination processing based on a threshold value that distinguishes a child from a small animal.

As described above, the biological information output device 10 according to the present embodiment includes the control unit 1, the Doppler sensor 2, the data acquisition unit 3, the information extraction unit 4, the occupant determination unit 5, and the information output unit 6.

According to the above configuration, the reception signal mainly includes information about a distance between the occupant and the reception unit 22, and the reception intensity becomes stronger as the distance between the occupant and the reception unit is shorter and the body size of the living body is larger. Further, when the occupant is at the same position, the distance between the occupant and the reception unit becomes closer as the occupant's body size becomes larger. As described above, the respiration cycle and the phase change amount due to respiration are greatly related to a body size of an occupant. Therefore, based on the reception intensity and the phase change amount, it is possible to more accurately determine the occupant regardless of the seating position of the occupant.

The information extraction unit 4 further includes an angular velocity calculation unit 42 that calculates an angular velocity from the displacement angle, and a biological information processing unit 43 that outputs biological information unique to a living body from the angular velocity. The occupant determination unit 5 determines an occupant (a type of a living body) based on the biological information.

According to the above configuration, it is possible to more accurately determine the type of the living body based on the biological information such as a respiration rate or a pulse rate.

### Embodiment 2

Another embodiment of the present invention is described below with reference to FIG. 2. For the convenience of description, components having the same functions as those in the description of Embodiment 1 are denoted by the same reference numerals, and description thereof is omitted.

In Embodiment 1, even if the distance, the reception intensity, and the phase change amount are correctly obtained, the occupant determination unit 5 may not be able to determine the occupant, which may cause a determination error. For example, any one of the distance, the reception intensity, and the phase change amount may not belong to a prescribed area on the map.

In the present embodiment, a configuration for reducing the number of cases in which such a determination error occurs will be described.

The occupant determination unit 5 creates a learning model in advance by performing machine learning based on teacher data, which uses a distance, a reception intensity, and a phase change amount as input data and uses occupant determination information that can be actually determined as output data. The occupant determination unit 5 modifies the map by, for example, changing a mapping function for creating the above-described map by learning, and determines the occupant according to the learning model.

When the vehicle is an owner car, it is easy to collect a large amount of teacher data because the occupant is almost fixed.

As described above, in the biological information output device 10 according to the present embodiment, the occupant determination unit 5 creates a learning model capable of realizing more various determination algorithms by repeating learning, and determines a type of a living body using the learning model. Thereby, the number of cases that cannot be determined can be reduced.

### Embodiment 3

Still another embodiment of the present invention will be described below with reference to FIG. 2. For the convenience of description, components having the same functions as those in the description of Embodiment 1 are denoted by the same reference numerals, and description thereof is omitted.

In Embodiment 1, the occupant is determined based on the reception intensity and the phase change amount that can be acquired from the occupant in a resting state. In contrast to this, in the present embodiment, the occupant is determined according to a state of the occupant.

For example, if a child gets tired of riding for a long time, he or she will not be able to stand still and start moving. Further, the angular velocity described above differs according to the movement of the occupant. For example, the angular velocity for large movements of the occupant is sufficiently large compared to the angular velocity for respiration.

The data acquisition unit 3 outputs the measurement data indicating the movement of the occupant for a predetermined period of time or longer without determining that the measurement data is abnormal data. In addition, the data acquisition unit 3 does not output the measurement data indicating the movement of the occupant for less than the predetermined time as the temporary movement of the occupant.

In the information extraction unit 4, the reception information processing unit 41 develops the I signal and the Q signal of the measurement data on the IQ plane. The angular velocity calculation unit 42 calculates the angular velocity of the reception signal point in the IQ plane based on the data obtained by the reception information processing unit 41 developing the I signal and the Q signal on the IQ plane, and outputs the angular velocity signal. Further, the occupant determination unit 5 determines that the occupant is a child when the magnitude of the angular velocity represented by the angular velocity signal from the angular velocity calculation unit 42 continues for a certain number of times or more within a predetermined time.

As described above, in the biological information output device 10 according to the present embodiment, the occupant determination unit 5 determines that the occupant is a child when the magnitude of the angular velocity calculated by the angular velocity calculation unit 42 is maintained to be equal to or greater than a predetermined value for the certain number of times or more within the predetermined time.

According to the above configuration, it is possible to determine an occupant made a large movement for a predetermined period of time or longer as a child. Thereby, it is possible to determine even an occupant who is not in a resting state.

### Implementation Example by Software

The control blocks (in particular, the information extraction unit 4 and the occupant determination unit 5) of the biological information output device 10 may be implemented by a logic circuit (hardware) formed on an integrated circuit (IC chip) or the like, or may be implemented by software.

In the latter case, the biological information output device 10 includes a computer that executes instructions of a program (biological information output program) which is software for implementing each function. The computer includes, for example, one or more processors and a computer-readable recording medium on which the program is recorded. In the computer, an object according to one or more embodiments of the inventions is achieved by the processor reading the program from the recording medium and executing the program. As the processor, for example, a central processing unit (CPU) can be used.

As the recording medium, tapes, disks, cards, semiconductor memories, programmable logic circuits, or the like can be used in addition to a “non-transitory tangible medium”, for example, read only memory (ROM), or the like. Further, a random access memory (RAM) or the like for developing the programs may be further provided.

The program may be supplied to the computer via any transmission medium capable of transmitting the program (a communication network or a broadcast wave or the like). Note that one embodiment of the present invention can also be implemented in the form of a data signal embedded in a carrier wave in which the program is embodied by electronic transmission.

### ADDITIONAL NOTES

According to one or more embodiments of the invention, it is not limited to the above-mentioned embodiments, and various modifications can be made within the scope shown in the claims, and embodiments obtained by appropriately combining technical means disclosed in different embodiments are also included in the technical scope of the present invention.

1. A biological information output device comprising:
an irradiation unit that irradiates a body surface of a living body with an electromagnetic wave;
a reception unit that receives a reflected wave of the electromagnetic wave reflected on the body surface;
a reception information processing unit that
outputs information about a distance to the body surface of the living body obtained by processing an I signal and a Q signal, the I signal being obtained by multiplying a signal of the electromagnetic wave and a signal of the reflected wave, and the Q signal being obtained by delaying the I signal by a predetermined phase,
outputs a reception intensity of the reflected wave using a diameter of a circle drawn by a signal point obtained by developing the I signal and the Q signal on a complex plane, and
outputs a phase change amount of the reflected wave using a displacement angle of a range where the signal point is displaced on the circle with respect to a center of the circle; and
a living body determination unit that determines a type of the living body based on the distance, the reception intensity, and the phase change amount.

2. The biological information output device according to claim 1, further comprising:
an angular velocity calculation unit that calculates an angular velocity using the displacement angle; and
a biological information processing unit that outputs biological information unique to the living body using the angular velocity,
wherein the living body determination unit determines the type of the living body based on the biological information.

3. The biological information output device according to claim 1,
wherein the living body determination unit creates a learning model by performing machine learning based on teacher data, which uses the distance, the reception intensity, and the phase change amount as input data and uses a type of the living body that can be actually determined as output data, and determines a type of the living body according to the learning model.

4. The biological information output device according to claim 1, further comprising:
an angular velocity calculation unit that calculates an angular velocity using the displacement angle,
wherein the living body determination unit determines that the living body is a child when a magnitude of the angular velocity calculated by the angular velocity calculation unit is maintained to be equal to or greater than a predetermined value for a certain number of times or more within a predetermined time.

5. A non-transitory computer-readable medium storing a biological information output program, when executed by a computer, causing the computer to function as each unit in the biological information output device according to claim 1.

6. A biological information output method comprising:
outputting information about a distance to a body surface of a living body obtained by processing an I signal and a Q signal, the I signal being obtained by multiplying a signal of an electromagnetic wave with which the body surface of the living body is irradiated and a signal of a reflected wave of the electromagnetic wave reflected on the body surface, and the Q signal being obtained by delaying the I signal by a predetermined phase;
outputting a reception intensity of the reflected wave using a diameter of a circle drawn by a signal point obtained by developing the I signal and the Q signal on a complex plane, outputting a phase change amount of the reflected wave using a displacement angle of a range where the signal point is displaced on the circle with respect to a center of the circle; and
determining a type of the living body based on the distance, the reception intensity, and the phase change amount.
